(19) United States
(12) Patent Application Publication
(10) Pub. No.: US 2009/0076977 A1
(43) Pub. Date: Mar. 19, 2009

(54) METHOD OF ASSIGNING SECURITIES TO A COUNTRY

(76) Inventors: Xin Yan, Bellevue, WA (US); Kelly L. Haughton, Gig Harbor, WA (US); Pradeep V. Velvadapu, Seattle, WA (US); Barry E. Feldman, Olalla, WA (US)

Correspondence Address: DAVIS WRIGHT TREMAINE, LLP/Seattle, 1201 Third Avenue, Suite 2200, SEATTLE, WA, 98101-3045, US

(21) Appl. No.: 11/858,100

(22) Filed: Sep. 19, 2007

(51) Int. Cl. G06Q 40/00

(52) U.S. Cl. 705/36 R

(57) ABSTRACT

A method of assigning securities to countries/regions. A company having a formation country/region, headquarters country/region, and primary exchange country/region issued each security. Countries/regions are classified as special, no domestic exchange (“NDE”), benefits driven incorporation (“BDI”), and non-BDI. Special rules apply to securities issued by companies formed in special countries/regions. Securities issued by companies formed in NDE countries/regions are assigned to their primary exchange countries/regions. Each security issued by a company formed in a non-BDI country/region is assigned to its formation country/region if its formation, headquarters, and primary exchange country/region are identical. If these three countries/regions are not identical and the formation country/region is a BDI country/region, the security is assigned to either the headquarters or primary exchange country/region. If these three countries/regions are not identical and the formation country/region is not a BDI country/region, the security is assigned to one of the formation, headquarters, or primary exchange country/region.

### BACKGROUND OF THE INVENTION

1. Field of the Invention

The present invention is directed to methods of assigning a security to a country or region, and more particularly, to methods of assigning securities included in a stock index to countries or regions.

2. Description of the Related Art

Stock market indexes are intended to represent an entire stock market or a portion of it and thus track changes in the market or a portion thereof over time. One purpose of an index is to serve as a performance benchmark. It measures an active investment portfolio's exposure and performance to the market opportunity set by representing a particular market or a portion of it. An index also serves as an asset class proxy by representing characteristics of an asset class without the influence of active management. Each index can have its own calculation methodology and is usually expressed in terms of a change from a base value. Thus, the percentage change is more important than the actual numeric value.

Indexes are created using various aggregations of securities. For example, some market indexes are intended to represent an entire stock market of a country or region and thus may be used to track changes in that market over time. Other indexes may include only securities of a particular type, securities issued by companies of a certain level of company total market capitalization, securities issued by companies within a particular industry, securities issued by companies belonging to a particular classification (e.g., growth stocks or value stocks), and so forth.

Using conventional approaches, a market is frequently defined as a country. Therefore, a market index typically measures the value of the stock market or a portion thereof for a particular country (e.g., United States, Japan, France, Germany, etc.). In more recent years, a need has arisen for regional and global indexes. Traditional regions include Europe, Asia, Asia Pacific, Latin America, and North America. However, under the conventional approaches, global indexes are constructed by first analyzing each country or region and then aggregating the results. For example, a large cap index will be determined for each country or region. Then, the large cap indexes will be combined to form a global large cap index.

The conventional approach considers each country or in some cases, each region separately because investment professionals believe the relationship between securities within a country or region is significant. Particularly, that relationship is more significant than any relationship between securities located in different countries or regions having a similar market capitalization. In other words, conventional wisdom in the art teaches that securities should be analyzed according to the country in which the security trades. Further, securities from different countries should be analyzed together as a single pool only if the countries are related in some manner (e.g., the countries are from the same geographic region).

Properly constructed global indexes are important because they may provide investors with a useful tool for making investment decisions. For example, a properly constructed global index may provide one or more of the following benefits:
1. a global equity market performance benchmark;
2. an equity market proxy for asset allocation analysis and decisions;
3. a purchasable vehicle for passive investment portfolios;
4. a comprehensive retirement plan and investment portfolio benchmark;
5. a foundation for trading;
6. a risk management tool, such as options and futures; and
7. an objective indicator of global market performance and characteristics for academic research and financial media.

Accurate assignment of a company to a country is an essential component of index construction because it places the company in its true country-based risk market. Additionally, assigning a country to each security within an index is important because many investment strategies involve under/over weighting securities from particular countries, or passive investment in securities from one or more countries. Indexes provide information that may be used by financial professionals when making weighting and/or passive investment decisions. Indexes may also provide performance benchmarks that may be used to evaluate the results of such decisions.

In most cases, country assignment is straightforward. However, some complexities of the global market warrant specific attention and rules. For example, financial professionals refer to some countries/regions, such as the British Virgin Islands, Bermuda, Cayman Islands, Liberia, and the like as “tax havens.” A clear one-to-one relationship does not exist between a tax haven country, companies formed (e.g., incorporated) in the tax haven country and exchanges on which securities associated with those companies are traded. In other words, not all companies formed in the Bahamas are properly classified as being from the Bahamas. In fact, if companies formed in the Bahamas are considered to be from the Bahamas, far more companies than are actually from the Bahamas will be considered to be from the Bahamas. Similarly, if securities traded in the Bahamas are considered to have been issued by companies from the Bahamas, far fewer companies will be considered to be from the Bahamas than were formed in the Bahamas. Assigning countries to securities from certain countries (e.g. Hong Kong and Macao) can also be complicated by past or current state ownership. Further, country assignment is complicated by the fact that a handful of countries, such as the Falkland Islands, Liechtenstein, Monaco, and Suriname, lack a domestic exchange.

Therefore, a need exists for methods of assigning a company, and thereby one or more securities issued by the company, to a country or region for the purposes of constructing an index.

### BRIEF DESCRIPTION OF THE SEVERAL VIEWS OF THE DRAWING(S)

FIG. 1 is a flow diagram of an exemplary embodiment of a method of assigning securities countries/regions.

FIG. 2 is a flow diagram of an exemplary embodiment of a method of classifying a country/region as a BDI country/region.

FIG. 3 is a flow diagram of an exemplary embodiment of a method of classifying a country/region as one of a special country/region, a BDI country/region, a NDE country/region, and a non-BDI country/region.

FIG. 4 is a flow diagram of an exemplary embodiment of a method of assigning a security to a particular country/region.

FIG. 5 is a flow diagram of an exemplary embodiment of a method of assigning a security issued by a company formed in a BDI region/country to a country/region.

FIG. 6 is a flow diagram of an exemplary embodiment of a method of assigning a security from Hong Kong to a particular country/region.

### DETAILED DESCRIPTION OF THE INVENTION

### Definition of Terms

Unless defined otherwise, technical and financial terms used herein have the same meaning as commonly understood by one of ordinary skill in the art to which this invention belongs. For purposes of the present invention, the following terms are defined below.

Benefits Driven Incorporation (“BDI”) company: a company formed (e.g., incorporated) in a BDI country/region.

Co-listing and Cross Listing Security: a security having shares traded on more than one exchange. The exchanges may include one or more domestic exchanges, one or more foreign exchanges, and a combination thereof.

Company Total Market Capitalization: the sum of the market capitalizations of all securities issued by a company.

Depositary Receipt: a negotiable financial instrument issued by a bank to represent a foreign company's publicly traded securities. The depositary receipt trades on a local stock exchange. Depositary receipts make it easier to buy shares in foreign companies. When the depositary bank is in the U.S., the instruments are known as American Depositary Receipts (“ADRs”). Banks outside of the U.S. issue global depositary receipts (“GDRs”).

Domestic Exchange: with respect to a security, an exchange residing in the same country/region in which the company that issued the security was formed.

Dual Listing Company: two listed companies under a contractual arrangement that operate as if they were a single economic enterprise, but retain separate legal identities, tax residencies, and stock exchange listings. Dual-listed companies have a different set of shareholders, but share ownership of all business operations. Additionally, shareholders retain existing shares with economic interest in the combined assets of both companies, and shareholders of each company have equivalent dividend, capital, and voting rights on a per share basis. An example of a dual-listed company is Unilever (UK) and Unilever NV (Netherlands).

Equity: a security representing an ownership interest in a company.

Free-Float Adjusted Market Capitalization: free-float adjusted market capitalization is calculated by multiplying a security's price by the number of shares readily available in the market. Instead of using all of the shares outstanding (as would be done using a full-market capitalization method), the free-float method excludes locked-in shares (such as shares in a large personal holding owned by the company itself or by a government) because such shares are not readily available for trading. The free-float method is typically considered to be a better way of calculating market capitalization because the free-float method provides a more accurate reflection of market movements. The resulting market capitalization calculated using a free-float methodology is smaller than a market capitalization calculated using the full-market capitalization method.

Foreign Exchange: with respect to a security, an exchange residing in a country/region other than the country/region in which the company that issued the security was formed.

Foreign Investors: investors from a country other than that in which a security is traded. For example, a U.S. citizen is a foreign investor if he/she is trading a security on a Chinese exchange.

Global Investable Market: a collection of investable securities traded on exchanges located all over the world. The global investable market is distinguishable from a traditional market, such as a country or a region (e.g., Asia, Europe, and the like), because the global investable market includes securities traded in countries and regions that were not traditionally combined and analyzed together as a single market.

Global Investable Total Market Capitalization: the sum of all of the total market capitalizations of securities issued by companies included in the global investable market.

Issue, Security, Company Relationship: an issue is stock-exchange specific. A security can have multiple issues that trade on different exchanges, while a company can have multiple security classes that are traded as different securities.

Issue/Listing Total Market Capitalization: the price from the exchange where the issue is traded multiplied by its total shares outstanding.

Investable Security: a security that has sufficient market capitalization, liquidity, and acceptable country and currency risk.

Local Shares: share of a security traded on its domestic exchange Market Capitalization: the number of shares outstanding of a company multiplied by their price per share.

No Domestic Exchange (“NDE”) country/region: a country or region that does not have a domestic exchange.

Primary Exchange: in general, a primary exchange for a security is a domestic exchange where the security is most liquid. Other factors such as inadequate liquidity on the domestic exchange, incorporation for benefit (tax, etc.), may influence the primary exchange assignment.

Primary Listing: an issue/listing of a security on its primary exchange.

Secondary Listing: an issue/listing of a security on an exchange other than its primary exchange.

Security Total Market Capitalization: the price of a security on its primary exchange multiplied by the total shares outstanding of the security. Depository receipts may be excluded from the security total market capitalization. However, under some circumstances, depository receipts may be considered in the free-float calculation.

Special Country/region: a country or region that has characteristics that differentiate it from a NDE country/region, a BDI country/region, and a non-BDI country/region. For example, the equity market of a special country/region may have unique characteristics due to its economic structure, state ownership of capital, and the like.

The term “country/region” is used herein to identify both internationally recognized countries as well as entities within those countries traditionally analyzed separately by financial professionals. For example, while Hong Kong is part of China, it is often analyzed separately for investment purposes. The term “country/region” may also refer to a combination of two or more countries. For example, Luxembourg and Belgium are typically combined in conventional investment analyses and may be referred to as a single country/region. Alternatively, some financial professionals may view each of Luxembourg and Belgium as separate countries. In essence, the term “country/region” is used to reflect the way a financial professional divides the world and these divisions may not necessarily strictly agree with political divisions, internationally recognized divisions, and the like.

### Overview

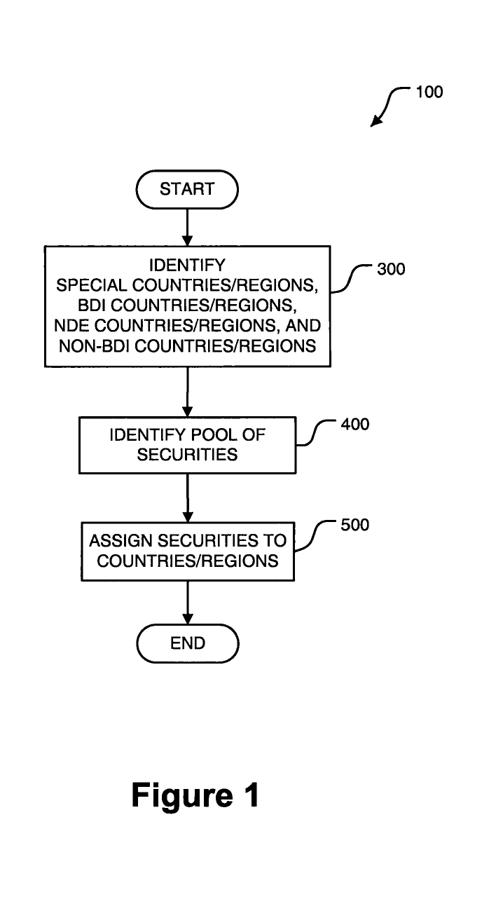

Referring to FIG. 1, aspects of the present invention relate to a method 100 of assigning securities to a particular country/region. The method 100 begins in block 300 with the identification of countries/regions that belong to each of the following classifications:

1. a special country/region;

2. a BDI country/region;

3. a NDE country/region; and

4. a non-BDI country/region.

Then, block 400 identifies a pool of securities. Finally, in block 500, each security identified in block 400 is assigned to a country/region. Securities issued by dual-listed companies may be treated as two separate securities. Therefore, securities issued by dual-listed companies may be assigned to separate countries/regions. However, different types of securities issued by the same company are assigned to the same country/region.

The following sections describe criteria that may be used to determine whether a country/region is a special country/region, a BDI country/region, or a NDE country/region.

### Special Countries/Regions

Countries/regions that have equity markets with unique characteristics may be classified as a special country/region. For example, a country/region may be classified as a special country/region if it has a unique economic structure, state ownership of capital, and the like. A country/region may be considered a special country/region if it includes two economic systems or two different capital market structures. For example, while China and Hong Kong share a common government, with respect to investability, Hong Kong and mainland China are exposed to different political risk and different currency risk. At this time, only two countries/regions may be considered special countries/regions: Macao and Hong Kong. However, as the world political landscape changes, additional countries/regions may become special countries/regions and/or one of the above countries/regions may no longer satisfy the special country/region criteria. Therefore, whether a particular country/region is a special country/region should be reevaluated occasionally.

### BDI Countries/Regions

A BDI country/region is a country or region that provides benefits beyond those provided by other countries/regions to companies that form (e.g., incorporate) within the BDI country/region. By way of example, a company domiciled in the U.S. may take advantage of the benefits of forming within a BDI country/region. Benefits provided may include operational benefits, tax advantages, political advantages, and the like. For example, companies from non-BDI countries/regions may incorporate in BDI countries/regions, like Bermuda, to escape regulations, such as the Sarbanes-Oxley Act (“SOX”) in the United States.

BDI countries/regions may be identified using information provided by the World Bank, International Monetary Fund, and the like. A BDI country/region is typically not associated with an active stock exchange (e.g., lacks a domestic exchange) although this is not a requirement. Generally speaking, a BDI country/region may be identified by determining the country/region in which a large company has formed is too small or underdeveloped to explain or justify the amount of direct strategic investment for asset allocation purposes (e.g., corporate presence) in the country/region. In essence, the size of the market is simply too small to justify the presence of the company or the apparent amount of the investment of company resources in the country/region.

For example, Bermuda is relatively small with a relatively small consumer market and industrial market. A relatively large company may be formed in Bermuda even though little or no significant business operations are located there; relatively few, if any customers may be located there; and its primary sources of revenue may be from elsewhere. The more significant the misalignment of these or other important elements of the business are with the country/region of formation, the stronger the indication that the country/region of formation is a BDI country/region for that company.

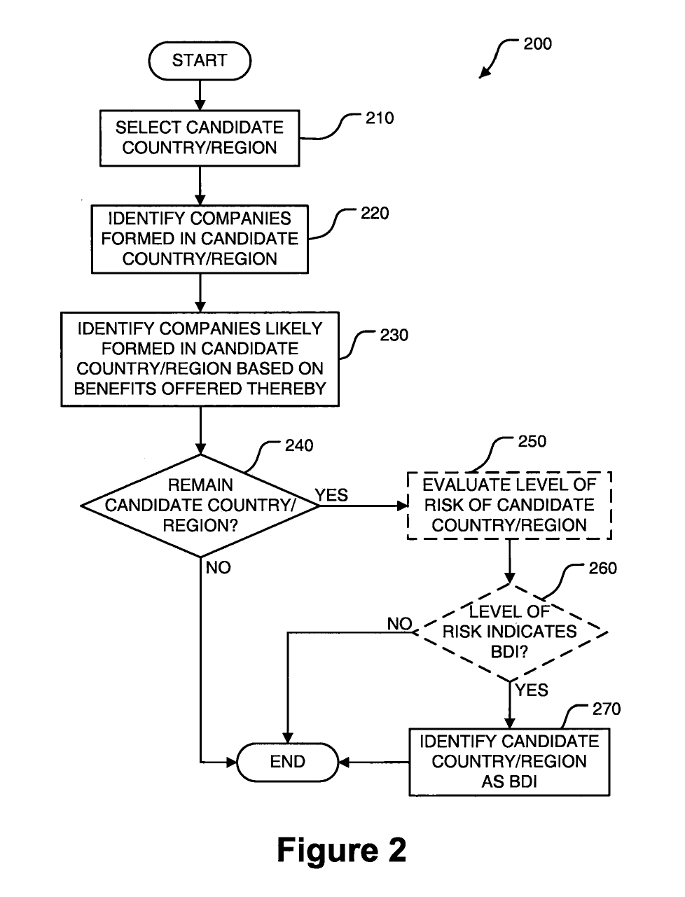

Referring to FIG. 2, a flow diagram of a method 200 of identifying BDI countries/regions is provided. In first block 210, a candidate country/region is selected. Candidate countries/regions may be identified by monitoring company trends. If a number of companies have reformed in a country/region having a small economy, it is likely that country/region is a BDI country/region. This method of identifying BDI countries/regions may include monitoring the domestic companies and former domestic companies of one or more major industrialized nations, identifying those companies that converted from a domestic company to a foreign company during a selected period of time, and identifying in which country/region those companies formed. The predetermined period of time may range from about one year to about five years.

Next, block 220 creates a list of companies formed in that candidate country/region. Then, block 230 narrows the list to include companies that likely formed in the country/region based on benefits offered thereby. In other words, the method 200 identifies BDI countries/regions by first identifying BDI companies. For example, block 230 may identify companies having significant liquidity on an exchange located outside the candidate country/region, companies having a significant portion of their revenue generated outside the candidate country/region, companies whose tax rate (e.g., corporate tax rate) would be significantly higher if they were formed in the countries where their stock is most liquid (i.e., exchanges located outside the candidate country/region), and the like.

A company has significant liquidity on an exchange located outside the candidate country/region if at least approximately 70% to at least approximately 90% of the trading volume of the company's stock was traded on one or more exchanges located outside the candidate country/region. By way of non-limiting example, a company has significant liquidity on an exchange located outside the candidate country/region if at least approximately 80% of the trading volume of the company's stock was traded on an exchange located outside the candidate country/region.

A company has a significant portion of its revenue generated outside the candidate country/region if at least approximately 50% to at least approximately 90% of the company's revenue is generated outside the candidate country/region. By way of non-limiting example, a company has a significant portion of its revenue generated outside the candidate country/region if at least approximately 70% of the company's revenue is generated outside the candidate country/region.

A company's tax rate is considered significantly higher if the company's tax rate increases at least approximately 10% to at least approximately 30%. Alternatively, a tax rate increase greater than approximately 20% may be considered significant.

It may be beneficial to narrow the list to companies having the following characteristics, which may be common to at least a portion of BDI companies:

(1) each company's tax rate would increase at least approximately 20% if it were to form in the country/region where its stock is most liquid;

(2) each company has at least approximately 70% of its revenue generated outside the candidate country/region; and

(3) at least approximately 80% of each company's shares are traded on an exchange outside the candidate country/region.

Optionally, it may be beneficial to narrow the list to companies having at least approximately 70% to at least approximately 90% of their operations located outside the candidate country/region. By way of non-limiting example, companies having at least approximately 80% of their operations located outside the candidate country/region may be removed from the list.

Additional criteria that may be used to identify BDI companies may be identified by examining BDI companies formed in regions/countries already identified as BDI countries/regions (i.e., countries/regions already known to offer formation advantages). In particular, companies formed in the candidate country/region may be compared to BDI companies formed in the candidate country/region. For example, many shipping companies have formed in Liberia or Panama. Companies individually may undertake detailed comparative analyses of the countries to determine which may be most favorable. Such analyses may include detailed analyses of tax; accounting; legal considerations, such as liability laws; capital formation related matters, and other considerations relevant to their business. The results of these individual company decisions are often reflected in patterns that disclose these underlying resulting preferences, such as the over-representation of Liberia and Panama as a country of formation for companies in the shipping business.

Decision block 240 determines whether the country/region selected in block 210 should remain a candidate country/region. Decision block 240 may determine “YES” if the number of companies remaining on the list is large compared to the number of companies on the list of all companies formed in the country/region. Alternatively, decision block 240 may determine “YES” if the companies remaining on the list comprise a large portion of the total market capitalization of the candidate country/region. For example, if the companies remaining on the list total at least approximately 70% to at least approximately 90% of a total of the market capitalizations of all companies formed in the candidate country/region, the decision block 240 may determine “YES,” the candidate country/region should remain a candidate country/region. Alternatively, if the companies remaining on the list total at least approximately 80% of a total of the market capitalizations of all companies formed in the candidate country/region, the decision block 240 may determine “YES,” the candidate country/region should remain a candidate country/region.

Decision block 240 may decide “NO” if too few companies remain on the list, the number of companies remaining on the list comprise a small portion of the total market capitalization of the candidate country/region, and the like. For example, if the companies remaining on the list total less than approximately 80% of a total of the market capitalizations of all companies formed in the candidate country/region, the decision block 240 may decide “NO” (i.e., the candidate country/region is not a BDI country/region). If decision block 240 decides “NO,” the method 200 terminates. If decision block 240 decides “YES,” and the method 200 is used to evaluate a level of risk associated with the candidate country/region, the method 200 advances to optional block 250. Otherwise, the method 200 advances to block 270.

Optional block 250 evaluates a level of risk associated with the candidate country/region. The level of risk may include a level of political risk, country risk (see discussion with respect to block 400 below), and the like. If optional block 250 has evaluated the level of risk, the method 200 advances to optional decision block 260, which determines whether the level of risk indicates the candidate country/region is a BDI country/region. If the candidate country/region has little to no impact on the company's economic and capital structure, optional decision block 260 determines the level of risk indicates the candidate country/region is a BDI country/region. Otherwise, decision block 260 determines the level of risk does not indicate the candidate country/region is a BDI country/region and the method 200 terminates. If decision block 240 decided “YES,” and optional blocks 250 and 260 were not executed or alternatively, optional decision block 260 decided “YES,” block 270 classifies the candidate country/region as a BDI country/region. Then, the method 200 terminates.

The method 200 may identify BDI countries/regions without misclassifying non-BDI countries/regions that offer benefits based on formation but have substantial domestic markets and domestic industry. For example, countries like the Netherlands and Luxembourg offer tax benefits and as a result many European/Global companies choose to form in the Netherlands or Luxembourg for tax reasons. With increased integration of European countries, this is becoming more and more popular. However, the Netherlands and Luxembourg are not BDI countries/regions because each has a substantial domestic market and domestic industry.

At the present time, non-limiting examples of BDI countries/regions include the following:

1. Antigua & Barbuda;

2. Bahamas;

3. Belize;

4. Bermuda;

5. British Virgin Islands;

6. Cayman Islands;

7. Channel Islands;

8. Faroe Islands;

9. Gibraltar;

10. Isle of Man;

11. Liberia;

12. Marshall Islands;

13. Netherlands Antilles; and

14. Panama.

### NDE Countries/Regions

If a country/region is not a BDI country/region and lacks a domestic exchange, the country/region is classified as a NDE country/region. At the present time, non-limiting examples of NDE countries/regions include the following:

1. Falkland Islands

2. Liechtenstein

3. Monaco

4. Suriname

However, as the world political landscape changes and countries evolve, additional countries may be identified that lack a domestic exchange. Further, one or more BDI countries/regions that lack a domestic exchange may no longer be classified as BDI countries/regions. Alternatively, one or more NDE countries/regions may open domestic exchanges. Therefore, whether a particular country/region is a NDE country/region should be reevaluated occasionally. For example, whether a particular country/region is a NDE country/region may be reevaluated periodically (e.g., annually, semi-annually, and the like).

As is appreciated by those of ordinary skill in the art, a particular country/region may through its own actions become a BDI, special, NDE, or non-BDI country/region. Therefore, whether a particular country/region is a BDI country/region depends upon its current policies and must be reevaluated occasionally. It may be beneficial to reexamine a country/region after its political system, regulatory system, taxation system, financial system, and the like has undergone significant modification. In particular, it may be beneficial to reevaluate a country's classification whenever the method 100 is performed. In some embodiments, a country/region is reevaluated periodically, (e.g., annually, semi-annually, and the like).

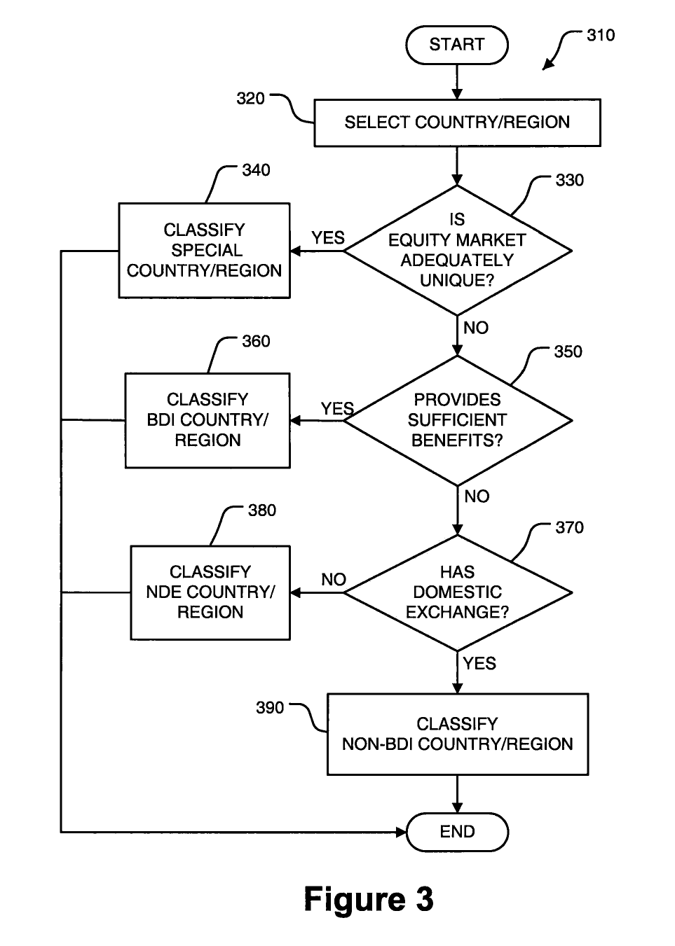

FIG. 3 illustrates a method 310 of implementing block 300 (i.e., a method of identifying each country/region within the set of countries/regions as a special country/region, a BDI country/region, a NDE country/region, and a non-BDI country/region). Optionally, block 300 may begin by selecting a set of countries/regions. Selecting the set of countries/regions may include aggregating information about securities obtained from vendors known to one of ordinary skill in the art as a source of such information. Exemplary vendors of such information include The Thomson Corporation (e.g., The Worldscope Global database) of Stamford, Conn., Telekurs Financial Information, Ltd. (e.g. Valordata feed) of Zurich, Switzerland, and the like. The aggregated information identifies the exchanges on which the securities trade, and thus provides a list of countries and regions.

In block 320, a country/region is selected from the set of countries/regions. In decision block 330, a decision is made whether the country/region has an adequately unique equity market to classify the country/region as a special country/region. If the decision is “YES,” in block 340, the country/region is classified as a special country/region. As mentioned above, at the present time, Macao and Hong Kong are classified as special countries/regions in block 340. Otherwise, the method 310 progresses to decision block 350.

In decision block 350, whether the selected country/region provides sufficient benefits to domestic companies to qualify it as a BDI country/region is determined. If the decision in decision block 350 is “YES,” in block 360, the country/region is classified as a BDI country/region. Otherwise, the method 310 progresses to decision block 370.

In decision block 370, whether the selected country/region has a domestic exchange is determined. If the decision is “NO,” in block 380, the country/region is classified as a NDE country/region. If the decision in decision block 370 is “YES,” the method 310 progresses to decision block 390 and classifies the country/region as a non-BDI country/region.

Returning to FIG. 1, after the identification of countries/regions in each classification, block 400 selects a pool of candidate securities for inclusion in the global market. The pool of candidate securities may include the list of aggregated global securities obtained from vendors known to one of ordinary skill in the art discussed above with respect to block 300. The pool of candidate securities may be filtered or screened to remove securities not considered to be investable by foreign investors. After the pool of securities has been filtered, the remaining securities are considered to be investable securities that represent a global investable market. While the term “global investable market” is used herein to refer to the screened pool of securities, screening is optional. Therefore, the term “global investable market” may also refer to a pool of securities that has not been screened as well as a pool of securities that has been filtered using methods other than those described below.

Methods of screening securities based on their availability for investment by foreign investors are well known to those of ordinary skill and need not be described herein. For example, candidate securities may be screened based on minimum liquidity and/or minimum company total market capitalization requirements.

Minimum liquidity requirements may screen securities that are traded in small volumes and/or are traded infrequently from the pool of candidate securities because such securities may not be considered minimally investable. By way of non-limiting example, two metrics, an Average Daily Trading Volume (“ADTV”) and an Active Trading Ratio (“ATR”) may be used to determine whether a particular security should be screened from the pool of candidate securities. Both of these metrics are calculated with respect to a security's primary exchange.

If a security trades on a single exchange, that exchange is the security's primary exchange. However, if issues of a security are traded on multiple exchanges, all of the exchanges on which the issues trade or a portion thereof may be considered. The candidate exchanges may be evaluated by calculating an Average Daily Trading Volume (“ADTV”) for at least a portion of the issues of each security in the pool. If a security has only a single issue, the ADTV is calculated for that issue. Alternatively, if a security has multiple issues, the ADTV may be calculated for a portion of those issues. For example, if the security has issues traded on one or more domestic exchanges, the ADTV may be calculated for only local (domestic) issues. Alternatively, the ADTV is calculated for all of the issues of a security.

ADTV is calculated by dividing an issue's trading volume accumulated during a predetermined time period by a selected number of days including all or a portion of the predetermined time period. The numerator, the issue's accumulated trading volume, is calculated by totaling the volume of the issue traded on its exchange over the predetermined time period. The trading volume may be measured in any currency, such as United States dollars, euros, and other currencies. Any suitable amount of time may be used as the predetermined time period. For example, the predetermined time period may be about one year. In some embodiments, the denominator (i.e., the number of days within a portion of the predetermined time period) is equal to the number of days the exchange associated with the issue was open for trading during the predetermined time period. Alternatively, the denominator may be equal to the number of days in the predetermined time period including non-trading days or a subset thereof (e.g., the number of days in the predetermined time period excluding weekends).

Then, the ADTV values of each of the issues of a security associated with a candidate exchange are compared and the exchange associated with the issue having the largest ADTV value is selected as the primary exchange. For example, the ADTV values of all of the local issues may be compared and the domestic exchange associated with the local issue having the largest ADTV value selected as the primary exchange. The issue traded on the primary exchange is the primary issue of the security. The ADTV value of a security is the ADTV value of its primary issue.

Then, the Active Trading Ratio (“ATR”) is calculated for each security in the pool. ATR is calculated by dividing the number of active trading days for the security's primary issue on the primary exchange by a selected number of days including all or a portion of a predetermined time period. The numerator, the number of active trading days, is calculated by totaling the number of days at least one share of the primary issue of the security was traded on its primary exchange within the predetermined time period. Any suitable amount of time may be used as the predetermined time period. For example, the predetermined time period may be about one year. The same predetermined time period may be used to calculate both the ADTV and the ATR or different time periods may be used. In some embodiments, the denominator (i.e., the number of days within a portion of the predetermined time period) is equal to the number of days the security's primary exchange was open for trading during the predetermined time period. Alternatively, the denominator may be equal to the number of days in the predetermined time period including non-trading days or a subset thereof (e.g., the number of days in the predetermined time period excluding weekends).

Next, the security is evaluated to determine whether it is adequately liquid using a minimum Active Trading Ratio threshold (“minimum ATR threshold”) and a minimum Average Daily Trading Volume threshold (“minimum ADTV threshold”). The minimum ATR threshold may be a predetermined value (e.g., 0.3, 0.45, 0.55, 0.65, 0.7, etc.) that identifies a portion of the days the primary exchange of the security was open for trading on which the primary issue of the security must have been traded. For example, the minimum ATR threshold may be approximately 0.5, which corresponds to the security's primary issue having been traded (e.g., at least one share was traded) on at least half of the days the primary exchange of the security was open for trading. Alternatively, the minimum ATR threshold may range from approximately 0.3 to approximately 0.7.

The predetermined value used for the minimum ATR threshold may be determined empirically from an analysis of the ATR values of a pool of securities. For example, the minimum ATR threshold may be determined by selecting an initial value (e.g., 0.3) and modifying the minimum ATR threshold until ATR values of securities traded infrequently and in large blocks are below the minimum ATR threshold. Any method known by those of ordinary skill in the art may be used to identify securities traded infrequently and in large blocks. Empirical determination of the minimum ATR threshold may also include identifying securities that should be found to be adequately liquid. These securities may be used to determine whether the minimum ATR threshold is too high and thus, is determining that adequately liquid securities are inadequate. Again, the minimum ATR threshold may be modified until ATR values of a satisfactory number of securities traded infrequently and in large blocks are below the minimum ATR threshold and a satisfactory number of adequately liquid securities are above the minimum ATR threshold. Any method known to those of ordinary skill in the art may be used to identify securities that should be found to be adequately liquid.

The minimum ADTV threshold may be calculated as a function of the ADTV values of the securities in the pool. For example, the minimum ADTV threshold may be set to a median ADTV value of the securities in the pool. For 2007, the median ADTV is approximately $150,000 USD. In some embodiments, the minimum ADTV threshold is a median ADTV value of a portion of the securities in the pool that excludes some securities. Non-limiting examples of securities that may be excluded include securities owned by a government, securities that are highly regulated by a government, and the like. Such securities (e.g., public utilities owned by some foreign governments) may be excluded because they have an ‘insulated’ price that is often slow moving or even static.

The minimum ADTV threshold may be set to statistics other than the median that are calculated as a function of the ADTV values of the securities in the pool, such as a mean, a median, a selected percentile, and the like. Further, constants may be added to such minimum ADTV thresholds. Additionally, the minimum ADTV threshold may be scaled. For example, the minimum ADTV threshold may be set equal to the median ADTV multiplied by a scale factor (e.g., 1.01, 0.98, and the like). It may be desirable to use a consistent formula or method to calculate the minimum ADTV threshold each time the index is reconstituted. In this manner, manual and/or inconsistent adjustment of the minimum ADTV threshold may be avoided. However, if an unusual or onetime event occurs, manual adjustment of the calculated minimum ADTV threshold may be necessary.

If the ADTV of a security is greater than or equal to the minimum ADTV threshold and the ATR of the security is greater than or equal to the minimum ATR threshold, the security is adequately liquid and a primary exchange exists for the security. If the ADTV of the security is less than the minimum ADTV threshold and/or the ATR of the security is less than the minimum ATR threshold, the security may not be adequately liquid. If only a portion of the exchanges on which issues of a security are traded (e.g., only domestic exchanges) were considered in determining the primary exchange of the security, it may be possible that another issue of the security is more liquid. In other words, a secondary issue may be identified as the primary listing and its exchange may be identified as the primary exchange for the inadequately liquid security. If a secondary issue is adequately liquid (i.e., has an ADTV value greater than or equal to the minimum ADTV threshold and an ATR value greater than or equal to the minimum ATR threshold), a primary exchange exists for the security. The adequately liquid secondary issue is identified as the primary issue and the exchange on which that issue trades is identified as the primary exchange.

If the local issues and foreign issues of a security are both found to be inadequately liquid but the security is traded as depository receipts, the depository receipts may be adequately liquid and may be considered the primary issue. In such cases, the exchange on which the adequately liquid depository receipts trade is identified as the primary exchange. Like securities, depository receipts may trade on multiple exchanges. Therefore, ADTV and ATR values for each exchange on which depository receipts trade are calculated. If any of the depository receipts have an ADTV value greater than or equal to the minimum ADTV threshold and an ATR value greater than or equal to the minimum ATR threshold, the security is adequately liquid and a primary exchange exists for the security. The exchange on which adequately liquid depository receipts trade is identified as the primary exchange.

If the security is not adequately liquid with respect to its local issues, foreign issues, and depository receipts, the security is inadequately liquid for inclusion in the pool of securities. Therefore, the security is screened from the pool of securities. Further, a primary exchange does not exist for the security.

Beyond the screen described above to determine whether a security is adequately liquid to be considered investable by foreign investors, other methods known in the art may be used.

The company total market capitalizations of the companies that issued the candidate securities may also be used to screen a portion of the securities from the pool. Minimum company market capitalization requirements may be used to screen securities from the pool of candidate securities that were issued by companies having a company total market capitalization below a predetermined minimum level. For example, the predetermined minimum level of company total market capitalization may range from about $50,000 USD to about $50,000,000 USD and is preferably about $1,000,000 USD. The minimum company total market capitalization may be determined empirically by experimenting with different values and identifying a value that screens companies for which screening is desired and fails to screen companies for which screening is not desired. Minimum company total market capitalization requirements may be used to screen extremely small equity securities that are effectively inaccessible to institutional investors from the pool of candidate companies.

Additionally, the safety and/or stability of the overall investment environment within a country/region from which a candidate security originates may be used to screen securities from the pool of candidate securities. Some countries do not provide sufficiently stable environments for institutional investment and for this reason, securities originating therefrom may be screened from the pool of candidate securities.

Methods of determining the adequacy of the investability conditions in a country/region are well known to those of ordinary skill in the art and the invention is not limited by the method used. For example, investability conditions in a country/region may be evaluated using a group of factors and reference materials. These factors include the country's political stability, capital market policies, corporate governance, competitiveness, de facto operating conditions, and trends in transaction volume and liquidity. Turning to reference materials, country risk ratings published by the Economist Intelligence Unit (“EIU”) division of The Economist Newspaper Limited of London, England, may be used to evaluate the safety and/or stability of the overall investment environment within a country/region. EIU is a leading international risk advisory service associated with The Economist newspaper, which is published by The Economist Newspaper Limited of London, England. EIU rates country risk by combined economic and political risk on a 100-point scale. Securities from countries considered high risk by EIU (e.g., category “D” or “E” countries) may be screened from the candidate companies.

In some embodiments, securities that are not equity or equity-like securities may be screened from the pool of candidate securities. Equity-like securities are those that represent ownership of a company without an obligation for the company to repay invested capital in the form of coupon payments or lump sum payments throughout the life of the investment. By way of example, the following types of securities may not be considered equity securities and may be excluded from the plurality of candidate securities:
1. Warrants and Rights
2. Trust Receipts and Royalty Trusts
3. Depository Receipts (with the exception of Depository Receipts for securities from The Philippines, Russia, and Thailand)
4. Limited Liability Companies
5. Closed-end Investment Companies
6. Limited Partnerships
7. Exchange Traded Funds (ETFs) and mutual funds

Additionally, some Bulletin Board as well as Pink Sheet Stocks and foreign equivalents thereto may be excluded if they are traded on an ineligible stock exchange. Pink Sheet stocks are over-the-counter (“OTC”) securities that do not meet the listing standards required to trade on major stock exchanges due to their limited capitalization and/or the limited number of shares outstanding. With a few exceptions, Pink Sheet stocks are small, thinly-traded issues that often carry a great deal of risk. Most Pink Sheet stocks are not very liquid. A Bulletin Board is an electronic quotation listing of the bid and asked prices of over the counter stocks that do not meet the requirements to be listed on the main board of an exchange.

An exemplary pool of candidate securities (e.g., share classes) organized by country/region is provided in Appendix A. The pool of candidate securities provided in Appendix A was determined as of July 2007.

Further, a portion of the securities may be removed from the pool of candidate securities. By way of non-limiting example, the smallest 2% of securities (as measured by security total market capitalization) may be removed from the pool. Alternatively, the smallest 0.5% of securities to the smallest 10% of securities may be removed from the pool.

If the method 100 is being used to assign the securities within a preexisting index to countries, the pool of securities identified in block 400 may include companies whose securities were already included in the preexisting index.

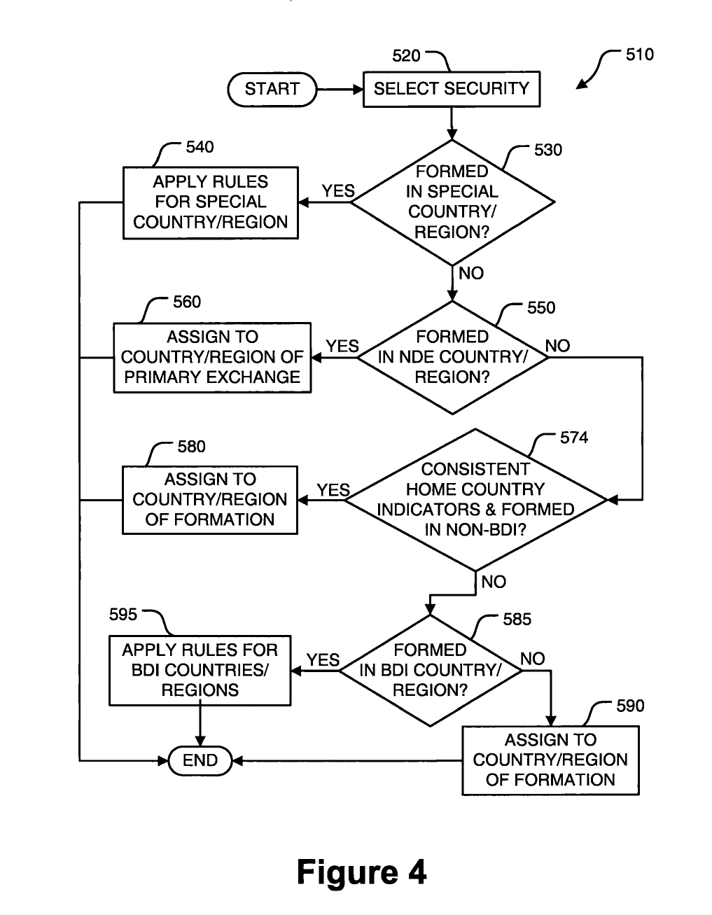

After the pool of securities is identified in block 400, each security is assigned to a country/region in block 500. FIG. 4 illustrates a method 510 of assigning each security to a country/region. Because decisions related to the assignment of a security to a country/region are based on aspects of the company that issued the security, different securities issued by the same company are assigned to the same country/region. The method 510 begins in block 520 with the selection of a security and advances to decision block 530.

Decision block 530 determines whether a company that issued the security was formed in a special country/region. If the determination is “YES,” in block 540, the security is assigned to a country/region based upon a set of rules designed for the special country/region of formation. If the determination is “NO,” the method 510 progresses to decision block 550.

Decision block 550 determines whether the security was issued by a company formed in a NDE country/region. If the determination is “YES,” block 560 assigns the security to the country/region in which its primary exchange is located. The primary exchange may have been identified in block 400. Alternatively, any method known in the art may be used to identify the primary exchange. If the determination of decision block 550 is “NO,” the method 510 progresses to decision block 574, which determines whether both the security's issuing company was formed in a non-BDI country/region and the security's issuing company's Home Country Indicators are consistent. Home Country Indicators include the issuing company's country/region of formation, the country/region wherein the issuing company's primary headquarters is located, and the country/region wherein the issuing company's primary exchange is located. The location of a company's headquarters may be determined from publicly available information such as corporate filings, annual reports, SEC filings, other filings, press releases, and the like. The primary exchange may have been identified in block 400. Alternatively, any method known in the art may be used to identify the primary exchange.

If the issuing company was formed in the same country/region where its headquarters and primary exchange are located, the Home Country Indicators are determined to be consistent. Alternatively, the Home Country Indicators may be determined to be consistent if the issuing company was formed in the same country/region where one of its headquarters and primary exchange are located. Further, the Home Country Indicators may be determined to be consistent if the issuing company's headquarters and primary exchange are located in the same country/region.

If all three of the issuing company's Home Country Indicators are determined to be consistent (i.e., identify the same country/region) and the security's issuing company was formed in a non-BDI country/region, in block 580, the security is assigned to the issuing company's country/region of formation. Alternatively, if the security's issuing company was formed in a non-BDI country/region and the Home Country Indicators were determined to be consistent because the issuing company's headquarters and primary exchange are located in the same country/region but it was formed in a different country/region, the security is assigned to the country/region where one of the issuing company's headquarters and primary exchange is located. For example, the security may be assign to the country/region where the issuing company's headquarters is located. Then, the method 510 terminates.

If the issuing company's Home Country Indicators are determined to be inconsistent (i.e., divergent) or the security's issuing company was formed in a BDI country/region, in decision block 585, whether the issuing company was formed in a BDI country/region is determined. If the issuing company was not formed in a BDI country/region, in block 590, the security is assigned to the country/region in which the issuing company formed. Alternatively, block 590 may assign the security to the country/region in which the issuing company's headquarters or primary exchange is located.

If the issuing company formed in a BDI country/region, block 595 assigns the security to a country/region according to a method 600, which assigns securities issued by a BDI company to a country/region. Then, the method 510 terminates.

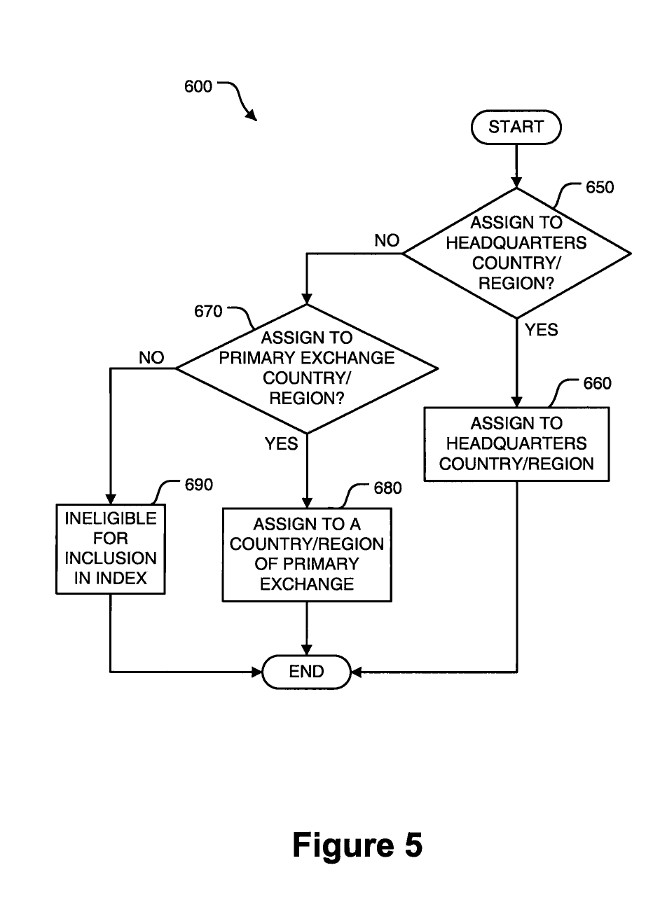

FIG. 5 is a flow diagram illustrating an exemplary embodiment of the method 600. In decision block 650, a decision is made whether to assign the security to the country/region in which the headquarters of the security's issuing company is located. If the headquarters of the BDI company is not located in a BDI country/region, decision block 650 decides “YES,” and block 660 assigns the security to the headquarters country/region. Then, the method 600 terminates. If the headquarters of the BDI company is located in a BDI country/region, decision block 650 decides “NO,” and the method 600 advances to decision block 670.

Optionally, if the headquarters of the BDI company is located in a NDE country/region, decision block 650 may decide not to assign the security to the country/region where the issuing company's headquarters is located and the method 600 may advance to decision block 670.

Decision block 670 determines whether to assign the security to the country/region in which its primary exchange is located. If the primary exchange of the BDI company is not located in a BDI country/region, decision block 670 decides to assign the security to the country/region where the issuing company's primary exchange is located, block 680 assigns the security to the primary exchange country/region, and the method 600 terminates. If the primary exchange of the BDI company is located in a BDI country/region, decision block 670 decides “NO,” and the method 600 advances to decision block 690.

If the primary exchange of the BDI company is located in a BDI country/region, decision block 670 decides “NO,” and in block 690, the security is found to be ineligible for inclusion in the index. Alternatively, the block 690 may assign the security to the country/region in which the issuing company was formed.

The primary exchange may have been identified in block 400. Alternatively, any method known in the art may be used to identify the primary exchange.

### Special Rules: Hong Kong

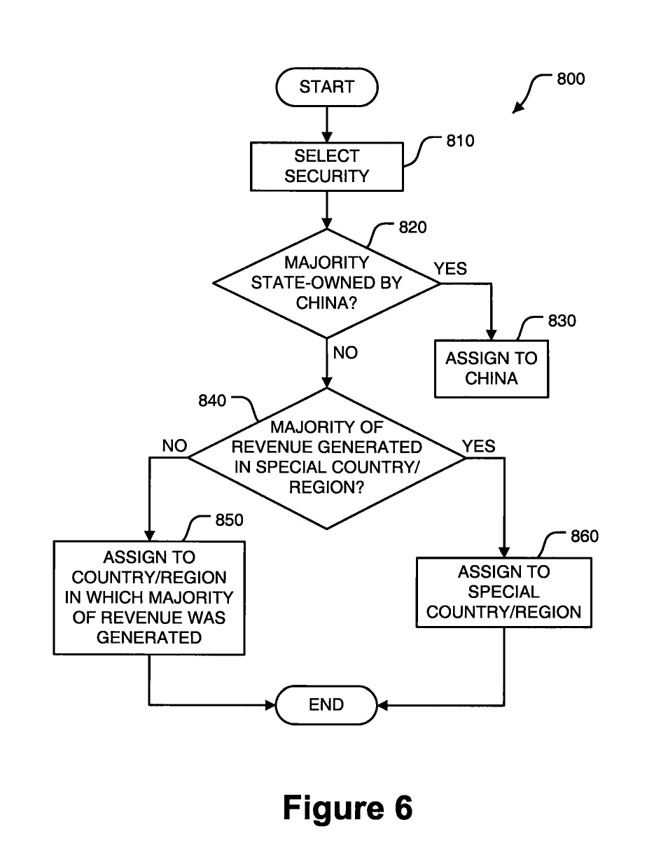

FIG. 6 is flow diagram illustrating an exemplary method 800 that implements a set of rules applied to a security from a special country/region, in this case Hong Kong. For the purpose of method 100, China and the Hong Kong Special Administrative Region may be treated as different countries/regions. In a first block 810, a security is selected that was issued by a company formed in Hong Kong.

Decision block 820 decides whether a majority portion of the security's issuing company is state-owned by China. If a majority portion of the security's issuing company is state-owned by China, block 830 assigns the security to China and the method 800 terminates. For example, China Mobile Ltd. is a state-owned company. Securities issued by China Mobile Ltd. are assigned to China in block 830. A majority portion of an issuing company may be at least approximately 50% to at least approximately 80%. If a majority portion of the security's issuing company is not state-owned by China, the method 800 proceeds to decision block 840.

Decision block 840 decides whether a majority portion of the issuing company's revenue is generated in a country/region other than the special country/region. A majority portion of the issuing company's revenue may be at least approximately 50% to at least approximately 80%. Whether a majority portion the issuing company's revenue is generated in a country/region other than Hong Kong may be determined from public information, such as corporate filings.

If decision block 840 decides “YES,” a majority portion of the issuing company's revenue is generated in a country/region other than the special country/region, block 850 assigns the security to the country/region in which the majority of its revenue is generated. For example, China Mobile Ltd. is the largest mobile telephone provider in China and its Chinese business accounts for more than half of the company's revenue. Securities issued by China Mobile Ltd. are assigned to China in block 850. After the security is assigned to a country/region, the method 800 terminates. If decision block 840 decides “NO,” (i.e., a majority portion of the issuing company's revenue is not generated in a country/region other than the special country/region), block 860 assigns the security to the special country/region. After block 860, the method 800 terminates.

### Special Rules: Macao

Securities issued by companies formed in Macao are assigned to Hong Kong.

### Special Rules: Individual Securities

A company owned by one or more governments may be located and formed in an unrelated country/region. Generally, these companies will lack objectively measurable indicators that identify to which country/region they should be assigned. However, financial professionals expect such companies to be assigned to specific countries. For example, European Aeronautic Defence and Space Company (“EADS”), the parent company of Airbus, is owned by Germany, Spain, and France. EADS formed in the Netherlands. The corporate headquarters of EADS is in the Netherlands. Further, EADS has issued stock that trades in the Netherlands. Financial professionals view EADS as a French company. Therefore, EADS is assigned to France even though no objective metric clearly identifies EADS as a French company. Other companies such as STMicroelectronics N.V., Euronext N.V., and the like may be handled in a substantially similar manner. In other words, companies owned by one or more governments and located within the boundaries of another unrelated government may be assigned to a country/region on an individual basis to conform to the expectations of financial professionals.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

APPENDIX A
(determined as of July 2007)

| Country | Eligible Share Classes |
|---|---|
| Argentina | Common Shares |
| Australia | Common shares |
| | Preferred shares |
| Austria | Common shares |
| | Preferred shares |
| | Participation certificates |
| Bahrain | Common Shares |
| Belgium | Common shares |
| | Preferred shares |
| Botswana | Common Shares |
| Brazil | Common shares |
| | Preferred shares |
| Bulgaria | Common Shares |
| Canada | Common Shares |
| | Units of Income Trusts |
| Chile | Common shares |
| | Preferred shares |
| China | B shares |
| | H shares |
| | N shares |
| Colombia | Common shares |
| | Preferred shares |
| Croatia | Common Shares |
| Cyprus | Common Shares |
| Czech Republic | Common Shares |
| Denmark | A shares |
| | B shares |
| Egypt | Common Shares |
| Estonia | Common shares |
| | Preferred shares |
| Finland | A shares |
| | B shares |
| | K shares |
| France | Common shares |
| | Preferred shares |
| | Investment certificates |
| | Voting certificates |
| Germany | Common shares |
| | Preferred shares |
| Ghana | Common Shares |
| Greece | Common shares |
| | Preferred shares |
| Hong Kong | A shares |
| | B shares |
| Hungary | Common Shares |
| Iceland | Common Shares |
| India | Common Shares |
| Indonesia | Common Shares |
| Ireland | Common Shares |
| Israel | Common shares |
| | Preferred shares |
| | ADRs |
| Italy | Common shares |
| | Preferred shares |
| | Savings shares |
| Japan | Common shares |
| Jordan | Common shares |
| Kuwait | Common shares |
| Latvia | Common shares |
| Lithuania | Common shares |
| Luxembourg | Common shares |
| Malaysia | Common shares |
| Mauritius | Common shares |
| Mexico | Common shares |
| | Participation certificate |
| Morocco | Common shares |
| Netherlands | Common shares |
| | Preferred shares |
| New Zealand | Common shares |
| | Preferred shares |
| Norway | A shares |
| | B shares |
| | Primary Capital Certificates |
| Oman | Common shares |
| Pakistan | Common shares |
| Peru | Common shares |
| | Preferred shares |
| | Investment shares |
| Philippines | Common shares |
| Poland | Common shares |
| Portugal | Common shares |
| Qatar | Common shares |
| Romania | Common shares |
| Russia | Common shares |
| | Preferred shares |
| Singapore | Common shares |
| Slovenia | Common shares |
| South Africa | Common shares |
| | Preferred shares |
| South Korea | Common shares |
| | Preferred shares |
| Spain | Common shares |
| Sri Lanka | Common shares |
| Sweden | A shares |
| | B shares |
| | C shares |
| Switzerland | Registered shares |
| | Bearer shares |
| | Participation certificates |
| | Dividend-right certificates |
| Taiwan | Common shares |
| | Preferred shares |
| Thailand | Common shares |
| | Preferred shares |
| Turkey | Common shares |
| United Arab Emirates | Common shares |
| United Kingdom | Common shares |
| United States | Common shares |
| Zambia | Common shares |

The invention claimed is:

1. A method comprising:
identifying at least one BDI country/region;
identifying a pool of global securities, each security having been issued by an issuing company formed in a formation country/region, the issuing company having a headquarters located in a headquarters country/region, and each security having a primary exchange located in a primary exchange country/region; and
for each security in a portion of the pool of global securities,
if the formation country/region, the headquarters country/region, and the primary exchange country/region are the same country/region and the formation country/region is not the at least one BDI country/region, assigning the global security to the formation country/region,
if the formation country/region is the at least one BDI country/region, assigning the global security to one of the headquarters country/region and the primary exchange country/region, and
if the formation country/region, the headquarters country/region, and the primary exchange country/region are not the same country/region and the formation country/region is not the at least one BDI country/region, assigning the global security to one of the formation country/region, the headquarters country/region, and the primary exchange country/region.

2. The method of claim 1, wherein for each global security in the portion of the pool of global securities,
if the formation country/region, the headquarters country/region, and the primary exchange country/region are not the same country/region and the formation country/region is not the at least one BDI country/region, the global security is assigned to the formation country/region.

3. The method of claim 1, further comprising:
identifying at least one NDE country/region; and
for each global security in the pool of global securities, if the formation country/region is the at least one NDE country/region, assigning the global security to the primary exchange country/region.

4. The method of claim 1, further comprising:
for each global security in the pool of global securities issued by an issuing company with a formation country/region that is Hong Kong, if a majority portion of the issuing company is owned by China, assigning the global security to China.

5. The method of claim 1, further comprising:
for each global security in the pool of global securities issued by an issuing company with a formation country/region that is Hong Kong, if a minority portion of the issuing company is owned by China and the issuing company generates a majority portion of its revenue in a country/region other than Hong Kong, assigning the global security to the country/region in which issuing company generates the majority portion of its revenue.

6. The method of claim 1, further comprising:
for each global security in the pool of global securities issued by an issuing company with a formation country/region that is Hong Kong, if a minority portion of the revenue generated by the issuing company was generated in a country/region other than Hong Kong, and a minority portion of the issuing company is owned by China, assigning the global security to Hong Kong.

7. The method of claim 1, further comprising, if the formation country/region is Macao, assigning the global security to Hong Kong.

8. The method of claim 1, wherein identifying the at least one BDI country/region comprises:
selecting a candidate country/region, a plurality of companies having formed in the candidate country/region, each of the companies of the plurality of companies formed in the candidate country/region comprising a market capitalization;
calculating a total market capitalization as a function of the market capitalizations of the plurality of companies formed in the candidate country/region;
identifying one or more BDI companies within the plurality of companies formed in the candidate country/region;
calculating a BDI total market capitalization as a function of the market capitalizations of the one or more BDI companies;
identifying the candidate country/region as the at least one BDI country/region if the BDI total market capitalization is greater than a predetermined percentage of the total market capitalization.

9. The method of claim 8, wherein the predetermined percentage of the total market capitalization is approximately 70% to approximately 90%.

10. The method of claim 8, wherein selecting the candidate country/region comprises:
identifying companies that were formed previously in a first country/region and during a selected period of time, reformed in a second country/region; and
identifying the second country/region as the candidate country/region.

11. A method comprising:
identifying a pool of global securities, each security having a primary exchange located in a primary exchange country/region and each security in the pool having been issued by an issuing company formed in a formation country/region;
classifying an appropriate portion of the formation countries/regions of the issuing companies of the securities in the pool of global securities as BDI countries/regions;
classifying an appropriate portion of the formation countries/regions of the issuing companies of the securities in the pool of global securities as NDE countries/regions;
classifying an appropriate portion of the formation countries/regions of the issuing companies of the securities in the pool of global securities as non-BDI countries/regions;
for each global security in the pool of global securities issued by an issuing company having a formation country/region classified as a NDE country/region, assigning the global security to the primary exchange country/region;
for each global security in the pool of global securities issued by an issuing company having a formation country/region classified as either a BDI country/region or a non-BDI country/region,
determining a headquarters country/region for the issuing company of the global security,
if the formation country/region, the headquarters country/region, and the primary exchange country/region are the same country/region, and the formation country/region is classified as a non-BDI country/region, assigning the global security to the formation country/region, and
if the formation country/region was classified as a BDI country/region, and at least one of the headquarters country/region and the primary exchange country/region are not classified as a BDI country/region, assigning the global security to one of the headquarters country/region and the primary exchange country/region.

12. The method of claim 11, further comprising, for each global security in the pool of global securities issued by an issuing company having a formation country/region classified as a non-BDI country/region,
if at least one of the headquarters country/region and the primary exchange country/region are not the same as the formation country/region, assigning the global security to one of the formation country/region, the headquarters country/region, and the primary exchange country/region.

13. The method of claim 11, further comprising, for each global security in the pool of global securities issued by an issuing company having a formation country/region classified as a non-BDI country/region,
if at least one of the headquarters country/region and the primary exchange country/region are not the same as the formation country/region, assigning the global security to the formation country/region.

14. A method of constructing a first securities index from a second index comprising a plurality of securities, each security in the plurality of securities comprising an issuing company formed in a formation country/region, the issuing company generating revenue, the issuing company having a primary exchange located in a primary exchange country/region, and a headquarters located in a headquarters country/region, the method comprising:
identifying a plurality of BDI countries/regions;
identifying at least one special country/region;
assigning a country/region to each security in the plurality of securities;
selecting at least one security from the plurality of securities of the second index based on the country/region assigned to the at least one security; and
constructing the first index from the at least one security selected from the plurality of securities of the second index,
wherein assigning a country/region to each security in the plurality of securities comprises:
if the formation country/region of the issuing company of the security is not the at least one special country/region and is not one of the plurality of BDI countries/regions, and the formation country/region does not have a domestic exchange, assigning the security to the primary exchange country/region;
if the formation country/region of the issuing company of the security is not the at least one special country/region, the formation country/region of the issuing company of the security is not one of the plurality of BDI countries/regions, and the formation country/region, the primary exchange country/region, and the headquarters country/region of the issuing company of the security are the same, assigning the security to the formation country/region; and
if the formation country/region of the issuing company of the security is not the at least one special country/region, and the formation country/region, primary exchange country/region, and headquarters country/region of the issuing company of the security are not the same,
if the formation country/region of the issuing company of the security is not one of the plurality of BDI countries/regions, and the formation country/region has a domestic exchange, assigning the security to one of the formation country/region, the primary exchange country/region, the headquarters country/region, and
if the formation country/region of the issuing company of the security is one of the plurality of BDI countries/regions, assigning the security to one of the headquarters country/region and the primary exchange country/region.

15. The method of claim 14, wherein the at least one special country/region identified comprises Hong Kong and Macao, and assigning a country/region to each security in the plurality of securities further comprises:
if the formation country/region is Macao, assigning the security to Hong Kong;
if the formation country/region is Hong Kong and a minority portion of the revenue generated by the issuing company was generated in a country/region other than Hong Kong, and a minority portion of the issuing company is owned by China, assigning the security to Hong Kong;
if the formation country/region is Hong Kong and a majority portion of the issuing company is owned by China, assigning the security to China; and
if the formation country/region is Hong Kong, the minority portion of the issuing company is owned by China, and a majority portion of the revenue generated by the issuing company was generated in a country/region other than Hong Kong, assigning the security to the country/region in which the majority portion of the revenue generated by the issuing company was generated.

16. The method of claim 14, wherein selecting the at least one security from the plurality of securities of the second index based on the country/region assigned to the at least one security comprises selecting securities from the plurality of securities of the second index assigned to at least one index country/region, the method further comprising identifying the at least one index country/region.

17. The method of claim 14, wherein assigning a country/region to each security in the plurality of securities further comprises: if the formation country/region of the issuing company of the security is not the at least one special country/region, the formation country/region, primary exchange country/region, and headquarters country/region of the issuing company of the security are not the same, the formation country/region of the issuing company of the security is one of the plurality of BDI countries/regions,
if the headquarters country/region of the issuing company of the security is not one of the plurality of BDI countries/regions, assigning the security to the headquarters country/region, and
if the headquarters country/region of the issuing company of the security is one of the plurality of BDI countries/regions, and the primary exchange country/region of the issuing company of the security is not one of the plurality of BDI countries/regions, assigning the security to the primary exchange country/region.

18. The method of claim 14, wherein assigning a country/region to each security in the plurality of securities further comprises: if the formation country/region of the issuing company of the security is not the at least one special country/region, the formation country/region, primary exchange country/region, and headquarters country/region of the issuing company of the security are not the same, the formation country/region, the headquarters country/region, and the primary exchange country/region are each one of the plurality of BDI countries/regions, determining the security is ineligible for inclusion in the first index.

19. A method of identifying a BDI country/region comprising:
selecting a candidate country/region, a plurality of companies having formed in the candidate country/region, each of the companies of the plurality of companies formed in the candidate country/region comprising a market capitalization;
calculating a total market capitalization as a function of the market capitalizations of the plurality of companies formed in the candidate country/region;
identifying one or more BDI companies within the plurality of companies formed in the candidate country/region;
calculating a BDI total market capitalization as a function of the market capitalizations of the one or more BDI companies;
identifying the candidate country/region as the at least one BDI country/region if the BDI total market capitalization is greater than a predetermined percentage of the total market capitalization.

20. The method of claim 19, wherein identifying one or more BDI companies within the plurality of companies formed in the candidate country/region comprises identifying one or more companies having significant liquidity on an exchange located outside the candidate country/region.

21. The method of claim 19, wherein each company of the plurality of companies formed in the candidate country/region has stock comprising a plurality of shares, and identifying one or more BDI companies within the plurality of companies formed in the candidate country/region comprises:
(1) identifying a company having a tax rate that would increase by at least approximately 20% if the company were reformed in a country/region where the company's stock is most liquid;
(2) identifying a company that generates at least approximately 70% of its revenue generated outside the candidate country/region; and
(3) identifying a company having at least approximately 80% of the shares in its plurality of shares traded on one or more exchanges outside the candidate country/region.

22. The method of claim 19, wherein identifying one or more BDI companies within the plurality of companies formed in the candidate country/region comprises identifying one or more companies generating significant revenue in countries/regions other than the candidate country/region.

23. The method of claim 19, wherein identifying one or more BDI companies within the plurality of companies formed in the candidate country/region comprises identifying one or more companies, each company identified comprising stock and a tax rate that would increase significantly if the company reformed in a country/region, other than the candidate country/region, in which the company's stock is most liquid.

24. The method of claim 19, wherein the predetermined percentage of the total market capitalization is approximately 70% to approximately 90%.

25. The method of claim 19, wherein selecting the candidate country/region comprises:
identifying companies that were formed previously in a first country/region and during a selected period of time, reformed in a second country/region; and
identifying the second country/region as the candidate country/region.
